(19) United States
(12) Patent Application Publication
(10) Pub. No.: US 2001/0022671 A1
(43) Pub. Date: Sep. 20, 2001

(54) Image processing apparatus

(76) Inventor: Akira Itoh, Ogori-shi (JP)

Correspondence Address: STEVENS, DAVIS, MILLER & MOSHER, L.L.P., 1615 L Street, N.W., Suite 850, Washington, DC, 20036, US

(21) Appl. No.: 09/781,982

(22) Filed: Feb. 14, 2001

(30) Foreign Application Priority Data
Feb. 17, 2000 (JP) 2000-039575

(51) Int. Cl. H04N 1/36

(52) U.S. Cl. 358/448; 358/410

(57) ABSTRACT

An image processing apparatus capable of preventing main scanning magnification discrepancies among a plurality of image data at low cost and with high precision. The apparatus includes a memory for storing control information specified by a CPU, an oscillator for generating a clock having a basic period equivalent to that of a unit pixel or less; variable frequency generators for adjusting a frequency of the clock to a predetermined level independently of each other on the basis of the control information; an image input connection for receiving predetermined data from an external device; image processors for converting parallel image data to serial image data on the basis of a frequency of clock outputted from associated one of the variable frequency generators; and an image output connection for transferring the serial image data to an external device.

### BACKGROUND OF THE INVENTION

The present invention relates to an image processing apparatus used as a peripheral apparatus of a computer, and an image processing apparatus capable of conducting fast processing using a laser beam.

In image processing apparatuses such as laser beam printers, there are increased in recent years opportunities of printing image data of a large capacity stored in a computer or the like at high speed and with a high image quality. In such image processing apparatuses, a technique of conducting superposion of image data of a plurality of colors and conducting full color printing is the mainstream.

In the conventional apparatuses, however, main scanning directional magnification discrepancies among image data or misalignment of printed colors are incurred from various causes at the time of superposition of image data. For conducting correct image position aligning, mechanisms of ultra-high precision become necessary in a mechanism system, an optical system, and so on, resulting in very expensive apparatuses.

### SUMMARY OF THE INVENTION

Therefore, an object of the present invention is to provide an image processing apparatus capable of preventing main scanning magnification discrepancies among a plurality of image data at low cost and with high precision. The object is achieved by the following aspects of the present invention.

According to an aspect of the invention, an image processing apparatus includes: central processing means for conducting operation control of the whole image processing apparatus; setting means for storing control information specified by the central processing means; clock generation means for generating a clock having a basic period equivalent to that of a pixel or less; a plurality of variable frequency generation means for adjusting a frequency of the clock outputted from the clock generation means to a predetermined level independently of each other, on the basis of the control information specified by the central processing means, the plurality of variable frequency generation means being provided respectively in association with a plurality of development colors; image input connection means for giving and receiving predetermined data to and from an external device; a plurality of image processing means for converting parallel image data inputted from the image input connection means to serial image data, on the basis of a frequency of a clock outputted from associated one of the variable frequency generation means, the plurality of image processing means being provided respectively in association with a plurality of development colors; and image output connection means for transferring the serial image data to an external device.

The clock frequency corresponding to each development color is thus adjusted on the basis of control information specified by the central processing means. As a result, it becomes possible to prevent main scanning magnification discrepancies among a plurality of image data at low cost and with high precision.

According to a further aspect of the invention, an image processing apparatus includes: central processing means for conducting operation control of the whole image processing apparatus; setting means for storing control information specified by the central processing means; clock generation means for generating a clock having a basic period equivalent to that of a pixel or less; a plurality of variable frequency generation means for adjusting a frequency of the clock outputted from the clock generation means to a predetermined level independently of each other, on the basis of the control information specified by the central processing means, the plurality of variable frequency generation means being provided respectively in association with development colors other than one predetermined color; image input connection means for giving and receiving predetermined data to and from an external device; a plurality of image processing means for converting parallel image data inputted from the image input connection means to serial image data, on the basis of a frequency of the clock outputted from the clock generation means and a frequency of a clock outputted from associated one of the variable frequency generation means by taking the frequency of the clock outputted from the clock generation means as a reference, the plurality of image processing means being provided respectively in association with all development colors; and image output connection means for transferring the serial image data to an external device.

As a result, the circuit is simplified, and the apparatus cost can be reduced.

According to above-mentioned second aspect of the invention, it has a further improvement comprising selection of either image data addition and removal processing to be conducted by the plurality of image processing means, or variable frequency processing to be conducted by the plurality of variable frequency generation means on the basis of control information specified by the central processing means.

As a result, it becomes possible to prevent main scanning magnification discrepancies among a plurality of image data at low cost and with high precision.

### BRIEF DESCRIPTION OF THE DRAWING

FIG. 1 is a block diagram showing an apparatus configuration of an image processing apparatus in an embodiment 1 of the present invention;

FIG. 2 is a block diagram showing a circuit configuration of the image processing apparatus of FIG. 1;

FIG. 3 is a block diagram showing a circuit configuration of fourth variable frequency generation means included in the image processing apparatus of FIG. 1;

FIG. 4 is an example of timing chart of fourth variable frequency generation means and image processing means in the image processing apparatus of FIG. 1;

FIG. 5 is a block diagram of an image processing apparatus in an embodiment 2 of the present invention;

FIG. 6 is a block diagram showing a circuit configuration of the image processing apparatus of FIG. 5; and

FIG. 7 is a block diagram showing a circuit configuration of fourth image processing means included in an image processing apparatus of an embodiment 3 of the present invention.

### DESCRIPTION OF THE EMBODIMENTS

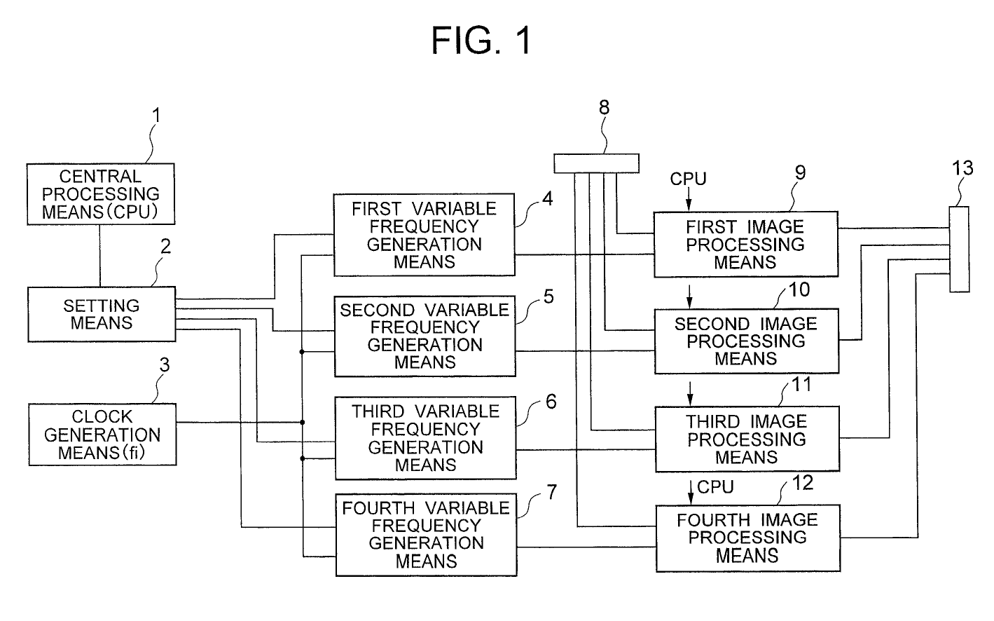

Hereafter, embodiments of the present invention will be described by referring to FIGS. 1 to 7. In FIGS. 1 to 7, the same components are denoted by like numerals. Duplicated description will be omitted.

### Embodiment 1

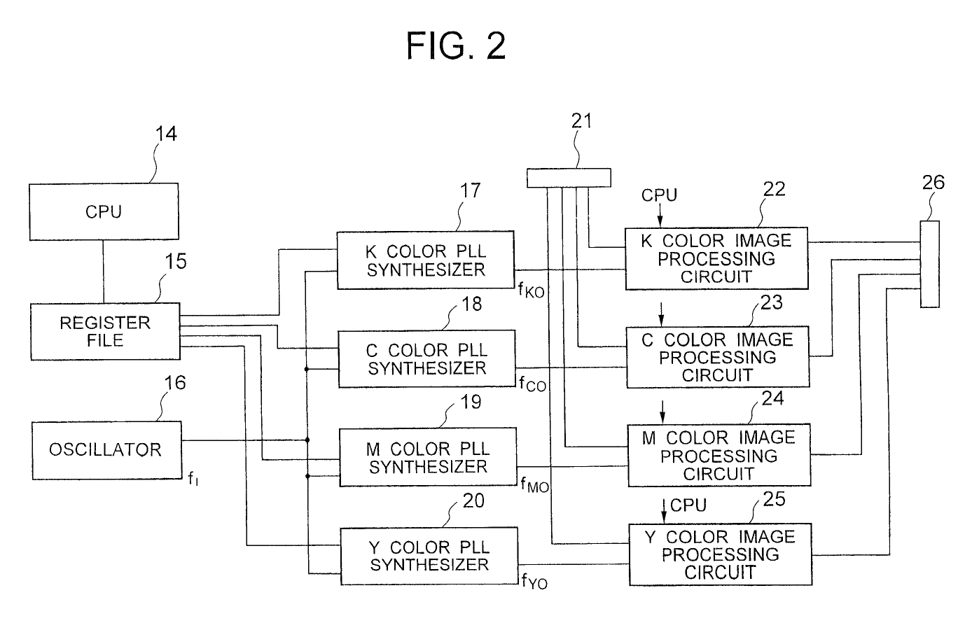

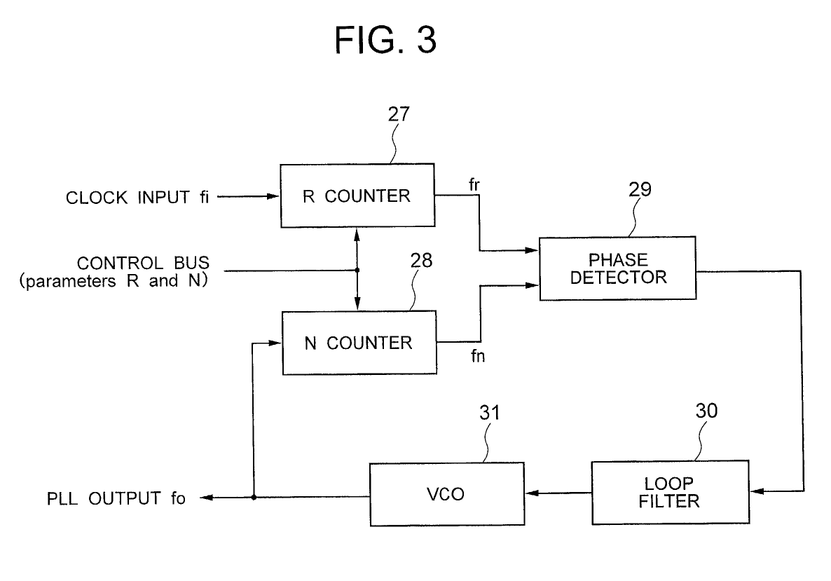

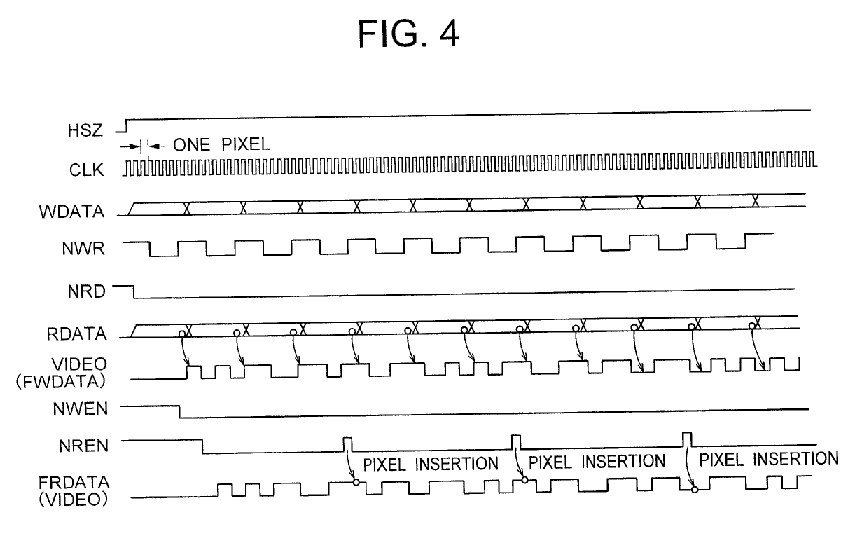

FIG. 1 is a block diagram showing an apparatus configuration of an image processing apparatus in an embodiment 1 of the present invention. FIG. 2 is a block diagram showing a circuit configuration of the image processing apparatus of FIG. 1. FIG. 3 is a block diagram showing a circuit configuration of fourth variable frequency generation means included in the image processing apparatus of FIG. 1. FIG. 4 shows a timing chart of the frequency generation means in the image processing apparatus of FIG. 1

As shown in FIG. 1, an image processing apparatus of the present embodiment includes central processing means 1 for conducting operation control of the whole image processing apparatus; setting means 2 for storing control information specified by the central processing means 1, clock generation means 3 for generating a clock having a basic period equivalent to a unit pixel or less. Namely the clock generation means 3 generates a clock pulse per each pixel, and is adapted so that the clock basic period may be changed to change pixel size. As examples for explanation, when assuming 64 nsec as a pixel scanning or writing period, the clock basic period equivalent to ½ pixel size becomes 32 nsec, and that equivalent to ⅛ pixel size becomes 8 nsec. It also includes first variable frequency generation means 4, second variable frequency generation means 5, third variable frequency generation means 6 and fourth variable frequency generation means 7, which are adapted for adjusting a frequency of the clock outputted from the clock generation means 3 to a respective predetermined level independently of each other, on the basis of control information specified by the central processing means 1. The first variable frequency generation means 4, second variable frequency generation means 5, third variable frequency generation means 6 and fourth variable frequency generation means 7 are provided respectively corresponding to a plurality of development colors. The apparatus also includes image input connection means 8 for giving and receiving predetermined data to and from an external device; first image processing means 9, second image processing means 10, third image processing means 11, and fourth image processing means 12 are also included and adapted for converting parallel image data inputted from the image input connection means 8 to serial image data, respectively, on the basis of a frequency of a clock outputted from associated one of the first variable frequency generation means 4, second variable frequency generation means 5, third variable frequency generation means 6 and fourth variable frequency generation means 7. The first image processing means 9, second image processing means 10, third image processing means 11, and fourth image processing means 12 are provided respectively corresponding to the plurality of development colors. The apparatus also includes image output connection means 13 for transferring the serial image data to the external device.

While in the present embodiment four variable frequency generation means 4 to 7 and four image processing means 9 to 12 are provided, the number of variable frequency generation means and image processing means is not limited to four, so long as as many variable frequency generation means and image processing means as the number of development colors are provided.

In FIG. 2, a central processing unit (hereafter referred to as “CPU”) 14 implements the central processing means, and controls the whole apparatus. A register file 15 implements the setting means 2. The register file 15 is connected to the CPU 14 and stores control information specified by the CPU 14. An oscillator 16 implements the clock generation means 3 and generates a clock having a fundamental period equivalent to a period of unit pixel or less.

A black (hereafter referred to as “K”) color PLL synthesizer 17 implements the first variable frequency generation means 4. A cyan (hereafter referred to as “C”) color PLL synthesizer 18 implements the second variable frequency generation means 5. A magenta (hereafter referred to as “M”) color PLL synthesizer 19 implements the third variable frequency generation means 6. A yellow (hereafter referred to as “Y”) color PLL synthesizer 20 implements the fourth variable frequency generation means 7. On the basis of control information specified by the CPU 14 connected to the register file 15, it becomes possible for the synthesizers 17 to 20 to adjust the frequency of the clock outputted from the oscillator 16 respectively independently.

A video input connector 21 implements the image input connection means 8. The image input connection means 8 is disposed between the present apparatus and an external device. A control bus for specifying a printing region and a data bus for giving and receiving image data to and from the external device are connected to the video input connector 21.

A K color image processing circuit 22 implements the first image processing means 9. A C color image processing circuit 23 implements the second image processing means 10. An M color image processing circuit 24 implements the third image processing means 11. A Y color image processing circuit 25 implements the fourth image processing means 12. The image processing circuits 22 to 25 conduct image processing such as skew correction processing or smoothing processing on parallel image data inputted from the video input connector 21, and then convert resultant data to serial image data.

A video output connector 26 implements the image output connection means 13. The video output connector 26 transfers the serial image data subjected to the image processing to the external device. The video output connector 26 is connected to an external image forming device such as a laser scanning unit (LSU) or an LED (light emitting diode). The processed image data is transferred to the external image forming device and printing is conducted. In the present apparatus, it is possible to independently process image data of a plurality of kinds such as cyan (C), magenta (M), yellow (Y) and black (B) colors.

FIG. 3 shows an internal circuit of the fourth variable frequency generation means 7 (Y color PLL synthesizer 20). By the way, an internal circuit of each of the first variable frequency generation means 4 (K color PLL synthesizer 17), the second variable frequency generation means 5 (C color PLL synthesizer 18), and the third variable frequency generation means 6 (M color PLL synthesizer 19) is the same as the internal circuit shown in FIG. 3. The variable frequency generation means 4, 5, 6 and 7 can be adjusted arbitrarily respectively independently of each other.

In FIG. 3, an R counter 27 and an N counter 28 are connected to the setting means 2 (register file 15). According to the parameter signals of R value and N value specified by the central processing means 1 (CPU 14) and supplied to the respective counters via control bus, the R counter 27 and the N counter 28 conduct R frequency division operation (i.e., dividing by R) and N frequency division operation (i.e., dividing by N). A phase detector 29 detects a phase difference between an output of the R counter 27 and an output of the N counter 28. A loop filter 30 smoothes an error signal outputted from a phase detector 29. On the basis of the smoothed error signal, a voltage controlled oscillator (hereafter referred to as “VCO”) 31 alters its oscillation frequency on the basis of the smoothed error signal.

As a result, the output of the clock generation means 3 (oscillator 16) is supplied to the R counter 27 as a clock input having a frequency fi. By frequency division with a divisor factor R, an internal clock having a frequency fr is generated. On the other hand, an output of the VCO 31 having a frequency fo is subjected in the N counter 28 to frequency division with a divisor factor N to generate an internal clock having a frequency fn. The phase detector 29 compares fr with fn and transfers a signal of difference between them to the loop filter 30 as an error component. The loop filter 30 smoothes this error signal and transfers a resultant signal to the VCO 31. And the VCO 31 alters the oscillation frequency on the basis of the smoothed error signal. In this way, control is effected so that fr and fn may finally become the same in frequency and phase.

As a result, it becomes possible to change the output frequency fo by setting the parameter values of R and N specified by the central processing unit 1 (the CPU 14), and the relation fo=(N×fi÷R) holds true. In the above explanation, very typical PLL synthesizers are used. Alternatively, a different architecture may also be used to implement similar variable frequency generation means.

Operation of the image processing apparatus of the present embodiment having the configuration heretofore described will now be described.

FIG. 4 shows a timing chart of the fourth image processing means 12 (Y color image processing circuit 25) in the image processing apparatus of the embodiment 1. A timing chart of each of the first image processing means 9 (K color image processing circuit 22), the second image processing means 10 (C color image processing circuit 23), and the third image processing means 11 (M color image processing circuit 24) is the same as the timing chart shown in FIG. 4. The image processing circuits 9 to 12 can operate respectively independently of each other.

In FIG. 4, HSZ denotes a status signal indicating an effective region of image data WDATA. When the HSZ becomes active, a certain external device starts transfer of WDATA in synchronism with the HSZ, and transfers WDATA of respective colors to respective image processing circuits via the image input connection means (video input connector 21).

When the HSZ becomes active, the fourth image processing means 12 generates an NWR pulse of a signal for controlling writing into an internal memory. As the internal memory, a memory of dual port type is used. Alternatively, a memory of single port type may also be used. At a rising edge of the NWR pulse, the internal memory stores 8-bit WDATA into a memory cell. Since WDATA of one color is transferred by taking 8 pixels as the unit, data storage into the memory (data storing operation) is also conducted by taking 8 pixels as the unit. However, these may be conducted by taking a different number of pixels as the unit.

The fourth image processing means 12 conducts image processing such as skew correction processing or smoothing processing on stored parallel image data. In general, in such image processing, a cycle steal method of conducting processing in a time region other than memory access time is used.

When image transfer of a first line is finished, the HSZ becomes negative and storage into the memory and the image processing are temporarily terminated. And when image transfer of a second line is started and the HSZ becomes active again, the fourth image processing means 12 generates an NWR pulse, and simultaneously therewith makes active a signal NRD for controlling readout from the internal memory. For convenience, signals subsequent to the NRD in FIG. 4 indicate operation of a second line.

When the NRD becomes active, the internal memory outputs 8-bit image data RDATA from memory cells. The outputted RDATA is transferred to a parallel to serial converter (hereafter referred to as “P/S” converter) included in the fourth image processing means 12. CLK denotes the basic clock fo generated by the fourth variable frequency generation means 7 (Y color PLL synthesizer 20). Here, pulses of the basic clock CLK are generated at equal intervals for respective pixels.

The P/S converter converts received RDATA to serial data in synchronism with the CLK and outputs resultant data as serial image data VIDEO. The serial image data VIDEO is transferred to an external image forming device, and printing is conducted.

Here, the above described relation fo=(N×fi÷R) holds true for the frequency of the CLK. By specifying parameter R values and N values of the first variable frequency generation means 4 (K color PLL synthesizer 17), the second variable frequency generation means 5 (C color PLL synthesizer 18), the third variable frequency generation means 6 (M color PLL synthesizer 19), and the fourth variable frequency generation means 7 (Y color PLL synthesizer 20) by using the central processing means 1 (CPU 14), therefore, it becomes possible to individually change the clock output fi of the single clock generation means 3 (oscillator 16) as the frequency fo of each color CLK (as shown by fKo, fCo, fMo, and fYo in FIG. 2). It is thus possible to freely change a size of formed pixel according to the fo (in the scanned direction).

As heretofore described, in the image processing apparatus of the present embodiment, the clock frequency corresponding to each development color is adjusted on the basis of control information specified by the central processing means 1. As a result, it becomes possible to prevent main scanning magnification discrepancies among a plurality of image data at low cost and with high precision.

### Embodiment 2

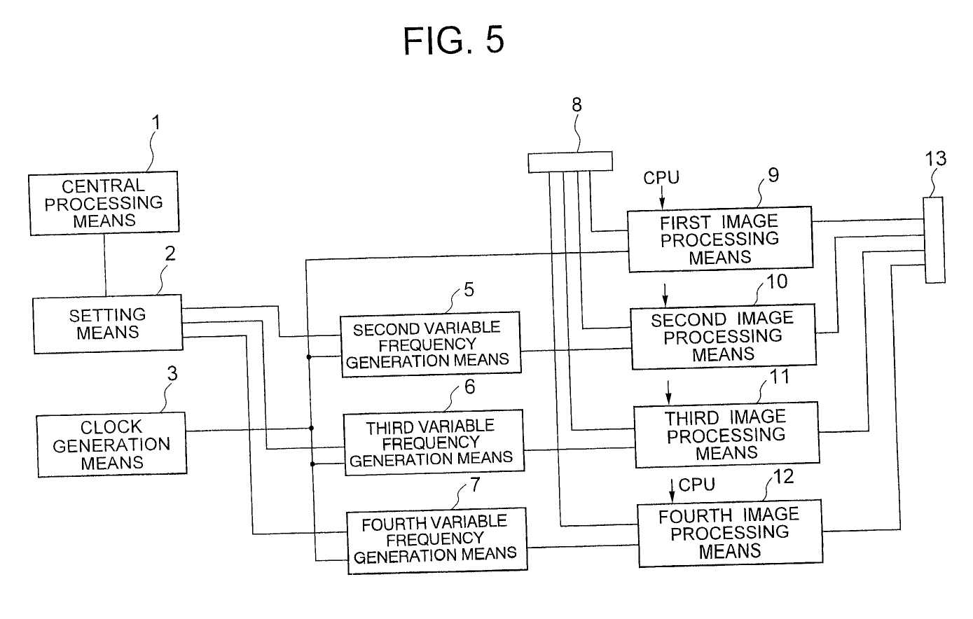

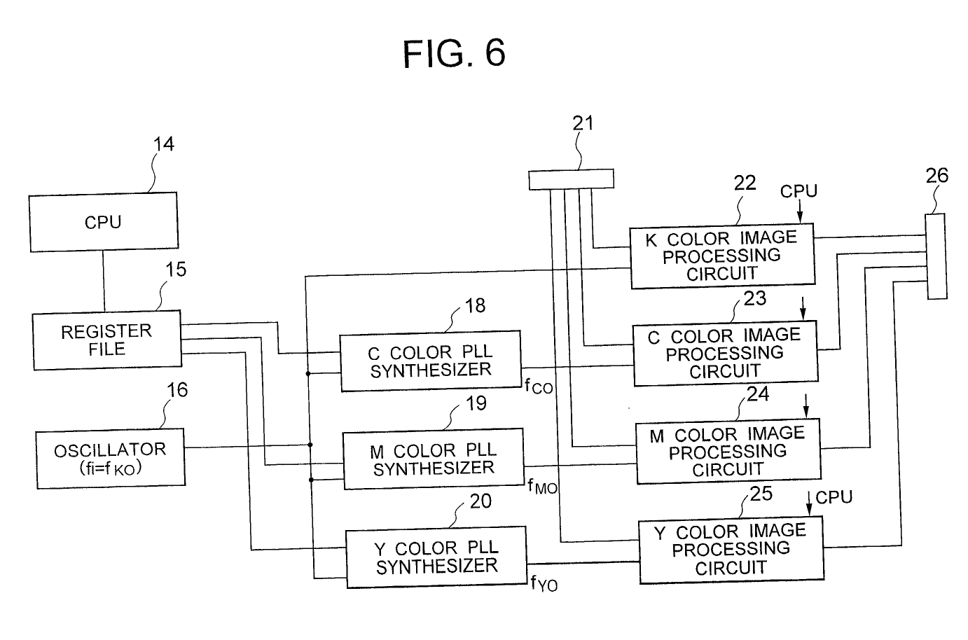

FIG. 5 is a block diagram showing an apparatus configuration of an image processing apparatus in an embodiment 2 of the present invention. FIG. 6 is a block diagram showing a circuit configuration of the image processing apparatus of FIG. 5.

An internal circuit of fourth variable frequency generation means 7 (Y color PLL synthesizer 20) in the image processing apparatus of the embodiment 2 is the same as the internal circuit of FIG. 3 already described. In addition, an internal circuit of each of second variable frequency generation means 5 (C color PLL synthesizer 18) and third variable frequency generation means 6 (M color PLL synthesizer 19) is also the same as the internal circuit of FIG. 3. Therefore, they can be arbitrarily adjusted in frequency respectively independently of each other.

In addition, a timing chart of fourth image processing means 12 in the image processing apparatus of the embodiment 2 is also the same as the timing chart of FIG. 4 already described. In addition, a timing chart of each of first image processing means 9 (K color image processing circuit 22), second image processing means 10 (C color image processing circuit 23) and third image processing means 11 (M color image processing circuit 24) is also the same as that of FIG. 4. Therefore, they can operate respectively independently of each other.

As shown in FIG. 5, the image processing apparatus of the embodiment 2 is obtained by removing the first variable frequency generation means 4 from the image processing apparatus of the embodiment 1 shown in FIG. 1. Accordingly, as shown in FIG. 6, the image processing apparatus of the embodiment 2 is obtained by removing the K color PLL synthesizer 17 from the image processing apparatus of the embodiment 1 shown in FIG. 2.

In the image processing apparatus of the present embodiment 2, a clock frequency fi supplied from the clock generation means 3 (oscillator 16) is used to replace the CLK frequency of the K color PLL synthesizer 17, which is used as a reference frequency. By specifying parameter R values and N values of the second variable frequency generation means 5 (C color PLL synthesizer 18), the third variable frequency generation means 6 (M color PLL synthesizer 19), and the fourth variable frequency generation means 7 (Y color PLL synthesizer 20) by using the central processing means 1 (CPU 14), the clock output fi of the single clock generation means 3 (oscillator 16) is individually changed as the frequency fo of each color CLK. A formed pixel is freely changed according to the fo.

By thus removing the first variable frequency generation means 4 (K color PLL synthesizer 17), the circuit is simplified and the cost can be reduced.

By the way, the removed variable frequency generation means may be one corresponding to any one of development colors.

### Embodiment 3

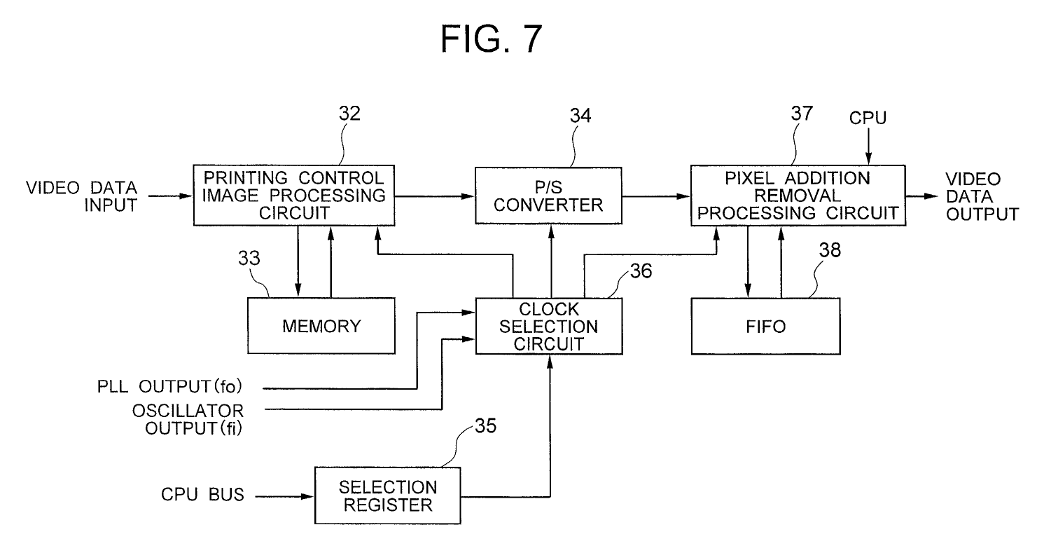

FIG. 7 is a block diagram showing a circuit configuration of fourth image processing means in an image processing apparatus in an embodiment 3 of the present invention.

The image processing apparatus of the embodiment 3 has the same apparatus configuration and circuit configuration as those shown in FIGS. 5 and 6. In addition, an internal circuit of each of second variable frequency generation means 5 (C color PLL synthesizer 18), third variable frequency generation means 6 (M color PLL synthesizer 19), and fourth variable frequency generation means 7 (Y color PLL synthesizer 20) is the same as the internal circuit of FIG. 3. Therefore, they can be arbitrarily adjusted in frequency respectively independently of each other. In addition, a timing chart of each of fourth image processing means 12 (Y color image processing circuit 25), first image processing means 9 (K color image processing circuit 22), second image processing means 10 (C color image processing circuit 23), and third image processing means 11 (M color image processing circuit 24) is also the same as the timing chart of FIG. 4. Therefore, they can operate respectively independently of each other.

In addition, an internal circuit of each of the first to the third image processing means 9 to 11 is the same as the internal circuit of the fourth image processing means 12 (Y color image processing circuit 25) shown in FIG. 7. Therefore, they can operate respectively independently of each other.

In FIG. 7, a printing control image processing circuit 32 stores inputted parallel video data into a memory 33. In addition, the printing control image processing circuit 32 conducts image processing such as skew correction processing or smoothing processing, reads out resultant data from the memory 33, and transfers the data thus read out to a P/S converter 34. The P/S converter 34 converts the parallel data to serial data in synchronism with CLK.

A pixel addition removal processing circuit 37 stores serial video data outputted from the P/S converter 34 into a first-in first-out memory 38 (hereafter referred to as “FIFO”) in synchronism with the CLK. In addition, the pixel addition removal processing circuit 37 conducts pixel addition and removal processing while reading out the serial video data from the FIFO 38.

A selection register 35 is connected to central processing means 1 (CPU 14) via CPU bus. The selection register 35 stores clock selection information specified by the central processing means 1 (CPU 14).

On the basis of selection information specified by the CPU 14, a clock selection circuit 36 selects a PLL output fo of the fourth variable frequency generation means 7 (Y color PLL synthesizer 20) or an output fi of clock generation means 3 (oscillator 16). The clock selection circuit 36 supplies the selected output, for example, clock of fo to the printing control image processing circuit 32, clock of fo to the P/S converter 34, and clock of fi to the pixel addition removal processing circuit 37.

In the case where image processing using the fourth variable frequency generation means 7 (Y color PLL synthesizer 20) is to be conducted, the central processing means 1 (CPU 14) stores in and sets the selection register 35 beforehand so as to select the corresponding PLL clock, and disables the pixel addition removal function of the processing circuit 37. The circuit 37 outputs image data signal from the P/S converter 34 to the output connector 36 without its pixel addition removal processing. As a result, it becomes possible to arbitrarily change the pixel size by only altering the above described parameter R values and N values.

On the other hand, in the case where image processing using the pixel addition removal processing circuit 37 is to be conducted, the CPU 14 sets the selection register 35 beforehand so as to select the output clock of the clock generation means 3 (oscillator 16), and enables the pixel addition removal processing circuit 37. As a result, processing using the pixel addition removal processing circuit 37 becomes possible.

FIG. 4 shows a timing chart of the fourth image processing means 12 (Y color image processing circuit 25).

In FIG. 4, HSZ denotes a status signal indicating an effective region of image data WDATA. When the HSZ becomes active, an external device starts transfer of WDATA in synchronism with the HSZ, and transfers WDATA of respective colors to respective image processing circuits via the image input connection means 8 (video input connector 21).

When the HSZ becomes active, the printing control image processing circuit 32 generates an NWR pulse of a signal for controlling writing into the memory 33. At a rising edge of the NWR pulse, the memory 33 stores 8-bit WDATA into a memory cell. Since WDATA of one color is transferred by taking 8 pixels as the unit, storage into the memory is also conducted by taking 8 pixels as the unit. However, these may be conducted by taking a different number of pixels as the unit.

The printing control image processing circuit 32 conducts image processing such as skew correction processing or smoothing processing on stored parallel image data. In general, in such image processing, a cycle steal method of conducting processing in a time region other than memory access is used. When image transfer of a first line is finished, the HSZ becomes negative and storage into the memory 33 and the image processing are temporarily terminated. And when image transfer of a second line is started and the HSZ becomes active again, the printing control image processing circuit 32 generates an NWR pulse, and simultaneously therewith makes a signal NRD for controlling readout from the memory 33 active. For convenience, signals subsequent to the NRD in FIG. 4 indicate operation of a second line.

When the NRD becomes active, the memory 33 outputs 8-bit RDATA from a memory cell. The outputted RDATA is transferred to the P/S converter. As described above, the CLK is the clock selected beforehand by the CPU 14, and the output fo of the fourth variable frequency generation means 7 (Y color PLL synthesizer 20) or the output fi of the clock generation means 3 (oscillator 16) is selected as a basic operation clock. Here, the CLK is a basic clock for designation of one (reference) pixel, and pulses of the CLK are generated at equal intervals for respective pixels.

The P/S converter 34 converts received RDATA to serial data in synchronism with the CLK and outputs resultant data as serial image data FWDATA.

When the HSZ signal becomes effective, the pixel addition removal processing circuit 37 enables a write control signal NWEN and starts storage of the FWDATA into the FIFO 38. When the write control signal NWEN is enabled, the FIFO 38 stores the FWATA successively into a memory cell in synchronism with the CLK.

After the FWATA is stored into the FIFO 38 as a cache, the pixel addition removal processing circuit 37 enables a readout control signal NREN and starts readout of serial image data FRDATA.

When the readout control signal NREN is enabled, the FIFO 38 outputs the FRDATA successively from the memory cell in synchronism with the CLK. Simultaneously therewith, time measurement is started by using the CLK as a reference. When an insertion interval set by the CPU 14 beforehand is reached, the readout control signal is disabled in synchronism with the CLK, readout of the FRDATA from the FIFO 38 is temporarily interrupted, and virtual or optional desired image data is added. As for the added image data, suitable pixels are added on the basis of values of neighboring pixels. For example, such an addition or insertion may be effected by various methods, for example, by adding or inserting a same value pixel (e.g., designate by Pa) as a just preceding pixel (e.g., designated by Pp), or by adding a same value pixel as a just subsequent pixel (by Ps), or by determining an added pixel Pa by combining such pixels Pp and Ps. A use may be made of a table defining a relation of Pp, Ps and Pa as follows:

| Pp | Ps | Ps |
|---|---|---|
| 0 | 0 | 0 |
| 0 | 1 | 0 |
| 1 | 0 | 0 |
| 1 | 1 | 1 |

A further method is also possible by determining an inserted pixel by a table defining a relation of Pa and pixels selected from those of from preceding nth pixels up to subsequent mth pixels (n, m: integer). The values of such neighboring pixels may be detected, for example, by storing the values to compare them and detect “1” or “0” of the values.

The above-processed serial image data FRDATA is transferred to an external image forming device via image output connection means 13 (a video output connector 26), and printing is conducted.

As heretofore described, main scanning magnification discrepancies among a plurality of image data can be prevented at lower cost and with high precision, by selecting either image data addition and removal processing to be conducted by a plurality of image processing means 9 to 12 or the frequency changing adjustment processing to be conducted by a plurality of variable frequency generation means 5 to 7, on the basis of control information specified by the central processing means 1.

While processing of adding virtual data pixels is conducted in the present embodiment, removal processing may be conducted in the same way. Furthermore, while the CLK is a unit (reference) pixel designation basic clock in the present embodiment, an image processing with pixels determined to be less than unit pixel also becomes possible by determining the CLK frequency for designation of a minute pixel, such as ⅛ pixel designation basic clock.

The clock frequency changing adjustments of the variable frequency generation means result in changing pixel sizes proportionally or linearly for the correction of the main scanning magnification, which makes possible to obtain more natural printed colors. On the other hand, the pixel addition removal processing circuits result in adding or removing minute or less pixels with reference pixels for the correction of the main scanning magnification, which makes possible a full digital processing therefor at a lower cost than that by the variable frequency generation means. Needless to say, it is possible to implement present image processing apparatuses having a control of at least one or of both in cooperation the variable frequency generation means and the pixel addition removal processing circuits.

According to the present invention, the frequency of the clock corresponding to each development color is adjusted on the basis of control information specified by the central processing means, as heretofore described. As a result, there is obtained an effective effect that it becomes possible to prevent main scanning magnification discrepancies among a plurality of image data at low cost and with high precision.

1. An image processing apparatus comprising:
central processing means for conducting operation control of the whole image processing apparatus;
setting means for storing control information specified by said central processing means;
clock generation means for generating a clock having a basic period equivalent to that of a pixel or less;
a plurality of variable frequency generation means for adjusting a frequency of the clock outputted from said clock generation means to a predetermined level independently of each other, based on the control information specified by said central processing means, said plurality of variable frequency generation means being provided respectively in association with a plurality of development colors;
image input connection means for receiving predetermined data from an external device;
a plurality of image processing means for converting parallel image data inputted from said image input connection means to serial image data, based on a frequency of a clock outputted from associated one of said variable frequency generation means, said plurality of image processing means being provided respectively in association with a plurality of development colors; and
image output connection means for transferring the serial image data to an external device.

2. An image processing apparatus comprising:
central processing means for conducting operation control of the whole image processing apparatus;
setting means for storing control information specified by said central processing means;
clock generation means for generating a clock having a basic period equivalent to that of a pixel or less;
a plurality of variable frequency generation means for adjusting a frequency of the clock outputted from said clock generation means to a predetermined level independently of each other, based on the control information specified by said central processing means, said plurality of variable frequency generation means being provided respectively in association with development colors other than one predetermined color;
image input connection means for receiving predetermined data from an external device;
a plurality of image processing means for converting parallel image data inputted from said image input connection means to serial image data, based on a frequency of the clock outputted from said clock generation means and a frequency of a clock outputted from associated one of said variable frequency generation means by taking the frequency of the clock outputted from the clock generation means as a reference, said plurality of image processing means being provided respectively in association with all development colors; and
image output connection means for transferring the serial image data to an external device.

3. An image processing apparatus according to claim 2, wherein said plurality of image processing means are adapted to conduct image data addition/removal processing operation, and said central processing means has control information to control at least one of the processing operation of said plurality of image processing means and the frequency adjusting operation of said variable frequency generation means.
